(19) United States
(12) Patent Application Publication
(10) Pub. No.: US 2019/0291916 A1
(43) Pub. Date: Sep. 26, 2019

(54) OPEN-WALLED PACK

(71) Applicant: Mars, Incorporated, McLean, VA (US)

(72) Inventors: Joel Cockcroft, Leicestershire (GB); Julie Winwood, Leicestershire (GB)

(73) Assignee: Mars, Incorporated, McLean, VA (US)

(21) Appl. No.: 16/325,063

(22) PCT Filed: Aug. 16, 2017
(86) PCT No.: PCT/US17/47179

§ 371 Date: Feb. 12, 2019

Related U.S. Application Data
(60) Provisional application No. 62/375,891, filed on Aug. 16, 2016.

(51) Int. Cl. B65D 5/16; B65D 5/02; B65D 5/10; B65D 5/42; B65D 5/54; B31B 50/26; B31B 50/73

(52) U.S. Cl. CPC B65D 5/16; B65D 5/0254; B65D 5/029; B65D 5/10; B31B 2120/302; B65D 5/4208; B65D 5/541; B31B 50/26; B31B 50/734; B65D 5/4204

(57) ABSTRACT

Embodiments described herein provide for a pack made of a unitary blank that may be folded into a rectangular cuboid. The pack defines a bottom, a top that is approximately parallel to and opposite of the bottom, and four walls that are approximately perpendicular to and disposed between the top and the bottom. The four walls include a first wall, a second wall, a third wall, and a fourth wall. The first wall is opposite of the third wall and the second wall is opposite of the fourth wall. First and second openings extend from the first wall to the third wall of the cuboid in a direction parallel to a bottom plane of the cuboid and from the top to an upper edge of the second wall and fourth wall respectively in a direction normal to the bottom plane of the cuboid. The upper edge of the second and fourth walls is disposed at a height in the range of 50 percent or greater of a distance from the bottom to the top of the cuboid.

### CROSS REFERENCE TO RELATED APPLICATIONS

This application claims priority to U.S. Provisional Application Ser. No. 62/375,891, filed Aug. 16, 2016, which is hereby incorporated by reference in its entirety.

### BACKGROUND

Sometimes it is desirable to include a window or opening in a pack to provide consumer visibility to products inside the pack prior to opening thereof. This product visibility can enable the consumer to better understand the product in the hopes that such understanding will lead to increased sales. Inclusion of a window or opening in a pack, however, can increase the complexity of constructing and filling the pack. The added complexity of constructing the pack can include both the added complexity in forming a blank and the added complexity of manipulating the blank to erect the pack. Additionally, inclusion of a window pane (e.g., a clear plastic sheet) over an opening on the blank adds cost as compared to an opening without a pane. Use of an opening without a pane, however, adds in the issue of the product being removed from the pack prior to opening.

Accordingly, there is a desire for a pack that provides visibility to the product(s) therein without allowing removal of the product(s) prior to opening the pack. Such a pack should desirably be easy to construct and low cost.

### BRIEF DESCRIPTION

Embodiments described herein provide for a pack comprising a unitary blank folded into a rectangular cuboid. The rectangular cuboid defines a bottom, a top parallel to and opposite of the bottom and four walls perpendicular to and disposed between the top and the bottom, the four walls including a first wall, a second wall, a third wall, and a fourth wall, the first wall opposite of the third wall, and the second wall opposite of the fourth wall. The second wall defines a first opening into the interior of the cuboid and the fourth wall defines a second opening into the interior of the cuboid. The first and second openings extend from the first wall to the third wall of the cuboid in a direction parallel to a bottom plane of the pack and extend from the top to an upper edge of the second and fourth walls respectively in a direction normal to the bottom plane of the pack. The upper edge of the second and fourth walls is disposed at a height in the range of 50 percent or greater of a distance from the bottom to the top of the cuboid.

Other embodiments described herein provide for a pack comprising a unitary blank folded into a rectangular cuboid. The rectangular cuboid defines a bottom, a top parallel to and opposite of the bottom, and four walls perpendicular to and disposed between the top and the bottom. The four walls are each formed of a respective wall panel. The wall panels include a first wall panel, a second wall panel, a third wall panel, and a fourth wall panel. The first wall panel is opposite of the third wall panel, and the second wall panel is opposite of the fourth wall panel. Respective wall folds form a boundary between the first wall panel and the second wall panel, between the second wall panel and the third wall panel, and between the first wall panel and the fourth wall panel. A fourth wall fold forms a boundary between the third wall panel and a tube-forming flap. The tube-forming flap is fastened to the fourth wall panel. The bottom is formed of a plurality of bottom flaps extending from respective wall panels, at least two of the bottom flaps may be fastened together. The top is formed of a first top flap extending from the third wall panel and a second top flap extending from the first wall panel. The first top flap is floating and the second top flap is disposed over at least a portion of the first top flap. The second top flap includes an intermediate panel, a distal panel, and a mid-flap fold demarcating the distal panel from the intermediate panel. The intermediate panel is disposed over at least a portion of the first top flap and the distal panel is disposed over a portion of, and fastened to, the third wall panel. The formed pack includes openings in one or more of the perpendicular walls, wherein the openings are defined by the upper edges of the perpendicular wall the opening is defined by, and the upper edge of the wall is disposed at a height of 50 percent or greater of a distance from the bottom to the top of the cuboid.

Yet other embodiments described herein provide for a method of erecting a pack. The method comprises forming a rectangular tube having four perpendicular walls and a bottom and placing items in the rectangular tube. The method also includes folding a first top flap inward, such that the first top flap is perpendicular to a third wall of the tube from which the first top flap extends. A second top flap is also folded inward, such that the second top flap is parallel to and disposed over at least a portion of the first top flap. A distal end of the second top flap, which extends beyond the first top flap, is folded inward such that the distal end of the second top flap is parallel to the third wall of the tube. The distal end of the second top flap can be removably fastened to the third wall of the tube.

### DRAWINGS

Understanding that the drawings depict only exemplary embodiments and are not therefore to be considered limiting in scope, some exemplary embodiments of the pack of the present disclosure will be described with additional specificity and detail through the use of the accompanying drawings.

FIG. 1 is a perspective view of an example pack that is easily constructible and provides visibility to product(s) provided therein.

FIG. 2 is another perspective view of the pack of FIG. 1.

FIG. 3 is a side view of the pack of FIG. 1.

FIG. 4 is a top view of a blank that can be folded to erect the pack of FIG. 1.

FIG. 5 is a bottom view of the pack of FIG. 1.

FIG. 6 is a view of the blank of FIG. 4 partially-erected into a pack of FIG. 1 and re-flattened.

FIG. 7 is a top view of the pack of FIG. 1 with first and second top flaps open.

FIG. 8 is a top view of the pack of FIG. 1 with the first top flap folded over the top and the second top flap open.

FIG. 9 is a top view of the pack of FIG. 1 with the first and second top flap folded over the top.

FIG. 10 is a back view of the pack of FIG. 1.

FIG. 11 is a top view of the pack of FIG. 1.

FIG. 12 is a perspective view of the pack of FIG. 1 with the releasable flap folded upward.

### DETAILED DESCRIPTION

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

Reference throughout the specification to “one example” or “an example” means that a particular feature, structure, or characteristic described in connection with an example is included in at least one embodiment. Thus, the appearance of the phrases “in one example” or “in an example” in various places throughout the specification is not necessarily referring to the same embodiment. Further, the particular features, structures or characteristics may be combined in any suitable manner in one or more embodiments.

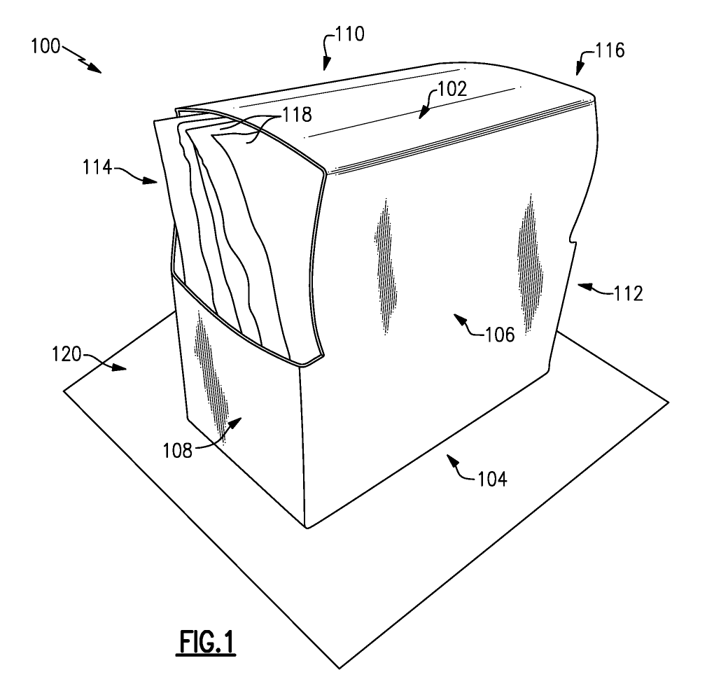

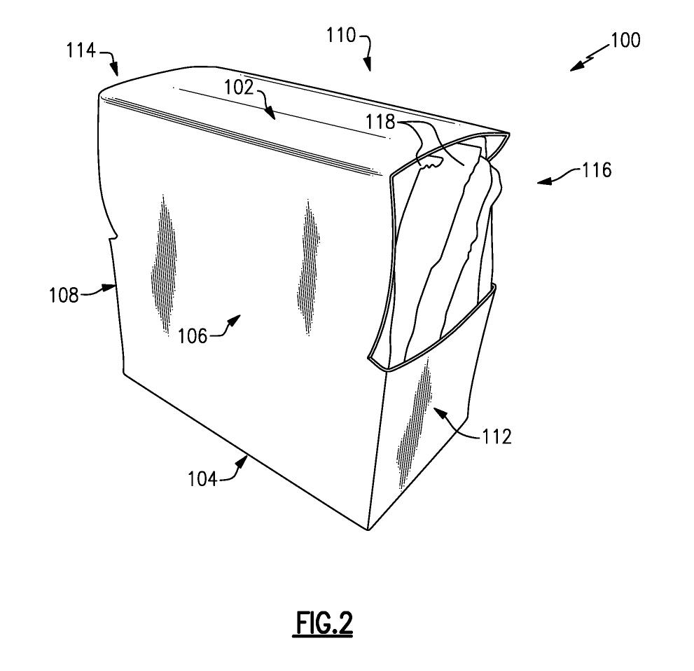

FIGS. 1 and 2 are perspective views of an example pack 100 that is easily constructible and that provides visibility to product(s) provided therein. In an example, pack 100 has a rectangular cuboid geometry including a bottom 104, a top 102, which is parallel to and opposite of the bottom 104, and four walls 106, 108, 110, 112, which are perpendicular to and disposed between the top 102 and the bottom 104. The four walls of the pack 100 include a first wall 106 and third wall 110, which are opposite one another, and a second wall 108 and a fourth wall 112, which are opposite one another and perpendicular to the first and third walls 106, 110. As used herein, a bottom plane 120 of the pack 100 is a plane defined by the bottom 104 of the pack 100. Thus, the walls 106, 108, 110, and 112 are approximately perpendicular to the bottom plane 120 and the top 102 is approximately parallel to the bottom plane 120.

In this example, the first and third walls 110 are longer than the second and fourth walls 108, 112 in a dimension parallel to the bottom plane 120 of the pack 100. In other examples, however, the dimensions of the rectangular cuboid can be different. Further, although walls 106, 108, 110 and 112 are shown having a specific geometry, any other geometries, shapes, or edge profiles can be used, provided that the openings 112 and 116 retain the desired function of assisting in retention of products 118 within pack 100 until top 102 is opened.

The pack 100 is rigid. As used herein, rigid means that the pack 100 can support its own weight maintain the rectangular cuboid geometry without further support when fully constructed. Fully constructed refers to the state in which the flaps and panels of the pack 100 that are intended to be fastened together are so fastened. FIGS. 1 and 2 are examples of the pack 100 in a fully constructed state. Rigid also means that the pack 100 can maintain its rectangular cuboid geometry during and through normal handling. Finally, as a rigid pack, the pack 100 does not conform to, and is not supported by, the contents (e.g., product(s) 118 and/or pressurized gas) within the pack 100. The pack 100 can be constructed from a single unitary blank, which can comprise any sufficiently rigid material, such as paperboard. This single unitary blank can be folded into a rectangular cuboid as explained through the present disclosure.

The pack 100 can define one or more openings 114, 116 into the interior of the pack 100. In an example, the one or more openings 114, 116 include a first opening 114 and a second opening 116 into the interior of the pack 100. The first and second openings 114, 116 can be without a pane (e.g., no clear plastic sheet covers the openings) in order to reduce cost and complexity and to provide improved consumer interaction with the product(s) 118 in the pack 100. Although multiple products 118 are shown in many of the figures herein, any number of products, such as a single product or multiple products, can be included within the pack. As shown, the openings 114, 116 are defined in the second and fourth walls 108, 112.

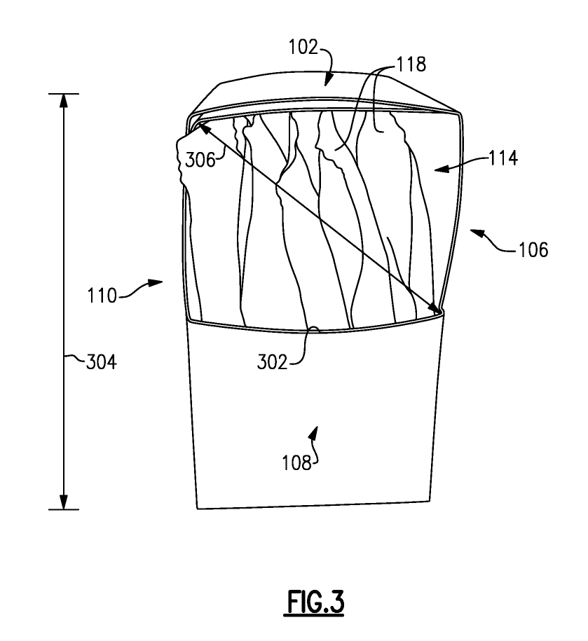

FIG. 3 is a view of the pack 100 showing the second wall 108 and first opening 114. The first opening 114 is primarily in the side of the cuboid corresponding to the second wall 108. As shown, the first opening 114 extends from the top 102 of the pack 100 downward to an upper edge 302 of the second wall 108 in a direction normal to the bottom plane 120 of the pack. The first opening 114 extends from the first wall 106 to the third wall 110 in a direction parallel to the bottom plane 120. Accordingly, the first opening 114 can have a generally rectangular shape, or any other shape that may be defined first wall 106, second wall 108, third wall 110 and fourth wall 112.

As a generally rectangular shape, the first opening 114 is defined by four edges. Two of the four edges extend in a direction parallel to the bottom plane 120 and the other two edges extend in a direction normal to the bottom plane 120. The two edges extending a direction normal to the bottom plane 120 are defined by the first wall 106 and third wall 110 respectively. The two edges extending in a direction parallel to the bottom plane 120 are defined by the top 102 and an upper edge 302 of the second wall 108. Thus, the opening 114 is defined on three edges by the faces of the cuboid adjacent to the second wall 108, in contrast to being defined by the second wall 108 itself on those edges.

Having the opening 114 in the second wall 108 extend to and be defined by the faces adjacent to the second wall 108 (i.e., the top 102, the first wall 106, and the third wall 110) provides a less complex pack 100 that is easy to construct. For example, since the second wall 108 does not extend up beyond its upper edge 302, there is no folding needed between the top 102 and the second wall 108 or between the upper portions of the first wall 106 and/or third wall 110 and the second wall 108. This lack of folding can be particularly advantageous when the pack 100 will be erected by hand-folding portions thereof. For example, if the second wall 108 were to have a portion that formed a border for the first opening 114 on any of the top, left, or right edges, this border portion would likely require a difficult folding step to fold the narrow border portion with respect to its adjacent face (e.g., top 102, first wall 106, third wall 110). Without such a border portion, the difficult folding step is not needed. Additionally, such a design allows for an opening 114 that has well supported edges, as each of the panels forming the edges of the opening 114 are stable by virtue of each of the panels being a structural component of the pack 100. The well-supported edges can frustrate an attempt to remove a product 118 from the pack 100 through the opening 114, prior to opening of the pack 100.

The size of the opening 114 in relation to the size and geometry of the product 118 determines how easily the product 118 could be removed through the opening 114 (without deconstruction or opening the pack 100). In this example, it is desirable not to allow the product to be removed through the opening 114 easily or at all. Accordingly, the upper edge 302 of the second wall 108 is disposed at a height that is 50 percent or greater of the distance 304 from the bottom 104 to the top 102 of the pack 100. Desirably, the upper edge 302 of the second wall 108 is disposed at a height that is in the range of 30 to 75 percent, or more preferably in the range of 33 to 75 percent, or 50 to 75 percent, or 55 to 75 percent, or 50 to 65 percent, or 55 to 65 percent of the distance 304 from the bottom 104 to the top 102 of the pack 100. In the example shown herein, the upper edge 302 is disposed approximately half way (i.e., 50% of the distance 304) between the top 102 and the bottom 104 of the pack 100. Thus, the opening 114 is approximately the same size as the panel making up the second wall 108.

In this example, the first opening 114 is disposed proximate the top 102 of the pack 100, such that the top of the first opening 114 is defined by the panel(s) making up the top 102 of the pack 100. In other examples, the first opening 114 is disposed proximate the bottom 104 of the pack 100, such that the bottom of the first opening 114 is defined by the panel(s) making up the bottom 104 of the pack 100 and the top of the first opening 114 is defined by a lower edge of the second wall 108. In such an alternative example, the second wall 108 can extend from the top 102 of the pack 100 downward to the lower edge, which defines the first opening 114.

In some examples such the example shown in the figures, the second opening 116 is identical to the first opening 114, except it is defined primarily in the fourth wall 112 instead of the second wall 108. Accordingly, the second opening 116 can have a generally rectangular shape that extends from the top 102 of the pack 100 downward to an upper edge of the fourth wall 112 in a direction normal to the bottom plane 120, and from the first wall 106 to the third wall 110 in a direction parallel to the bottom plane 120. In other examples, either of the first opening 114 or second opening 116 may not be included and/or the first and second opening 114, 116 can have different sizes from one another.

In this example, a plurality of products 118 are held within the pack 100. Each of the products 118 is a package containing one or more smaller items. In an example, the smaller items are a pet chew or treat; however, any desirable item can be included in the pack 100 and/or in a package that is provided within the pack 100. In this example, each product 118 is a flexible sachet having a generally planar geometry. Each product 118 has a geometry with a height and width defined as perpendicular dimensions that are within a longitudinal plane of the product 118. The height and width of each product 118 corresponds to the height and width of the first and third walls 106, 110, wherein the height of the walls 106, 110 is a dimension normal to the bottom plane 120 and a width is a dimension along the face of the walls 106, 110 parallel to the bottom plane 120. As a generally planar geometry, a thickness of each product 118 (normal to a longitudinal plane thereof) is less than one third of the smaller of the height and the width of the product 118.

The products 118 may be oriented in the pack 100 such that the longitudinal plane of the products 118 is parallel with the first and third walls 106, 110 of the pack 100. The edges of each of the products 118 may be approximately aligned with one another such that each product 118 is disposed with its adjacent major surfaces facing an adjacent product 118. The openings 114, 116 are defined in the walls 108, 112 of the pack 100 that are proximate the left and right edges of the products 118, as opposed to the walls that are proximate the major faces of the front or back product 118 in the group. Thus, a consumer can see multiple (e.g., all) products 118 in the pack 100 through the openings 114, 116.

The size of each opening 114, 116 is coordinated with the size of the products 118 such that a product 118 cannot be easily removed through an opening 114, 116 without opening or otherwise deconstructing the pack 100. This coordination includes setting a diagonal 306 of each opening 114, 116 sufficiently smaller than the height and width of each product 118. In an example, the longest diagonal 306 of each opening 114, 116 is less than ¾ of the smaller of the height and the width of a product 118.

In order to restrict the size of the openings 114, 116, the edges of openings 114, 116 defined by the top 102, the first wall 106, and the third wall 110 can extend all the way to, or close to, a plane defined by the second wall 108 and fourth wall 112, respectively. In an example, the edges of the top 102, first wall 106 and third wall 110 that define the openings, 114, 116 are, at all points, within 5 cm, and in a particular example within 2 cm, of the plane defined by the second wall 108 and fourth wall 112, respectively.

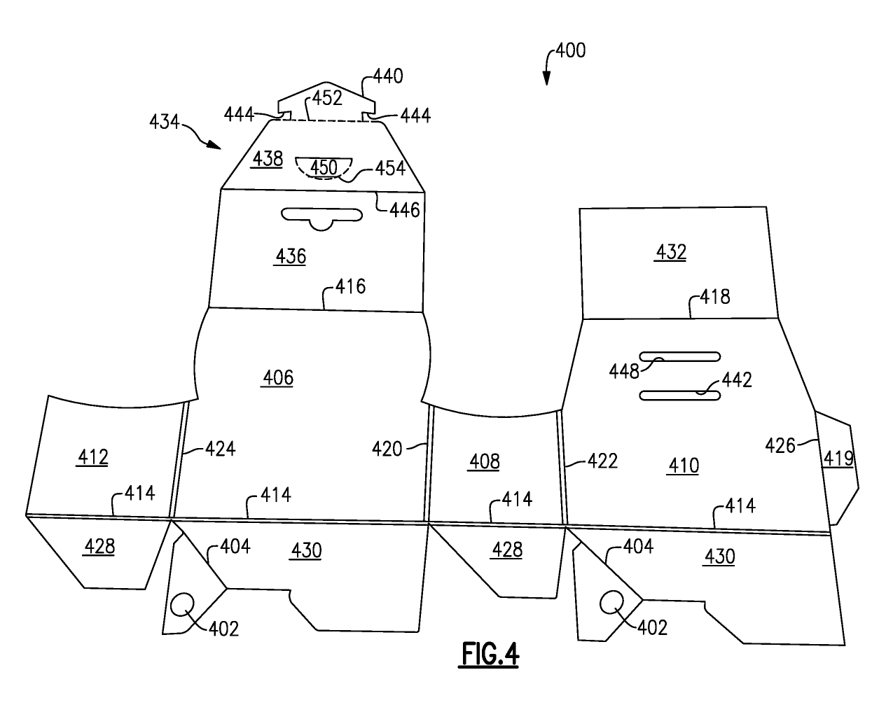

FIG. 4 is a top view of an example unitary blank 400 that can be folded to form pack 100. As mentioned herein, the blank 400 comprises a rigid material as known in the art, such as paperboard. The blank 400 includes four wall panels 406, 408, 410, 412, each of which form a wall 106, 108, 110, 112 of the pack 100. A plurality of top flaps 432, 434 and a plurality of bottom flaps 428, 430 extend from the wall panels 406, 408, 410, 412, and form the top 102 and bottom 104 of the pack 100 among other things.

Constructing the pack 100 includes forming a blank 400 and then erecting the pack 100 from the blank 400. Erecting the pack 100 includes folding and fastening together the blank 400 to form the pack 100 from the blank 400. The blank 400 can be made by cutting a sheet of material into the shape of blank 400 in any manner known to those in the art. This can include cutting with a knife, saw, laser, or other means.

As the walls 106, 108, 110, 112 of the pack 100 are within a common region (defined in a direction normal to the bottom plane 120) of the fully constructed pack 100, the wall panels 406, 408, 410, 412 of the blank 400 are within a common band on the blank 400. In particular, the bottom fold line 414 of each of the wall panels 406, 408, 410, 412 is aligned with the bottom fold lines 414 of the other wall panels 406, 408, 410, 412 to form a single bottom fold line 414. Likewise, the top fold line 416 of the first wall panel 406 is aligned with the top fold line 418 of the third wall panel 410.

A respective fold line demarcates adjacent wall panels 406, 408, 410, 412. These fold lines include a first-second fold line 420 demarcating the first wall panel 406 from the second wall panel 408, a second-third fold line 422 demarcating the second wall panel 408 from the third wall panel 410, and a fourth-first fold line 424 demarcating the fourth wall panel 412 from the first wall panel 406.

To erect the pack 100, the blank 400 starts in a single plane as shown in FIG. 4. The blank 400 can then be folded along the first-second wall panel line 420 to bring a tube-forming flap 419 extending from a wall panel 410 on a first end of the band of wall panels into contact with a wall panel 412 on the opposite end of the band of wall panels. The tube-forming flap 419 is within the band of wall panels 406, 408, 410, 412 such that it aligns with the opposite end wall panel when the blank 400 is folded along the first-second wall panel line 420. The tube-forming flap 419 can be folded along wall fold line 426 and fastened to the wall panel 412 with, for example, an adhesive 402. Although in this example, wall panel 410 and wall panel 412 are on the respective ends of the band, in other examples other wall panels (e.g., 406, 408) can be on the ends.

Once the tube-forming flap 419 is fastened to the opposite wall panel 412, the blank 400 can be expanded by folding along each of the wall fold lines 420, 422, 424, 426 to form a ninety-degree angle between each adjacent wall panel 406, 408, 410, 412. This forms a rectangular tube from the blank 400. As used herein the term “rectangular tube” or “tube” refers to a hollow structure having an approximately rectangular cross-section.

The bottom 104 of the pack 100 can be formed by fastening together a plurality of bottom flaps 428, 430 extending from the wall panels 406, 408, 410, 412. In this example, the plurality of bottom flaps includes two minor bottom flaps 428 and two major bottom flaps 430. The two major bottom flaps 430 can include respective features which can be mechanically coupled with one another to fasten the bottom flaps 428, 430 together when forming the bottom 104. As used herein, “mechanically coupled” means that two features are held together by contact between the two features without the use of a fastener (e.g., adhesive, staple, etc.).

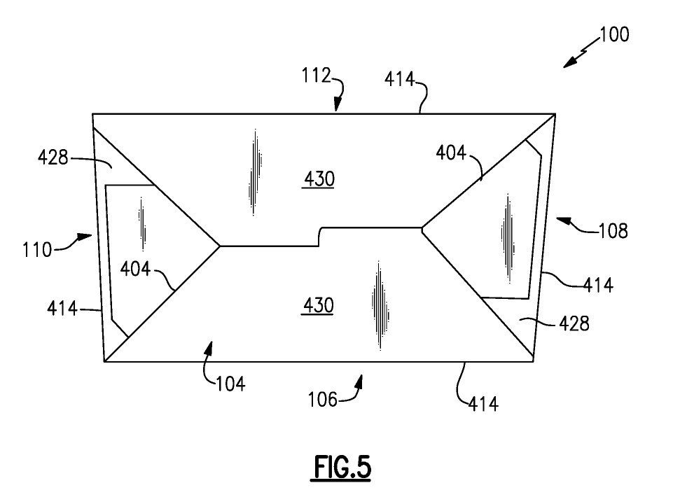

FIG. 5 is a bottom view of the erected pack 100. As shown, the plurality of bottom flaps 428, 430 are fastened together to hold the flaps 428, 430 in a position in which they extend perpendicularly to the wall panels 406, 408, 410, 412, and in parallel with the top 102. In this example, a portion of each major bottom flap 430 is disposed external to, and adhered to, a respective minor bottom flap 428. The two major bottom flaps 430 are mechanically coupled together by having extended portions of the major bottom flaps 430 disposed internal to portions of the opposite major bottom flap 430. That is, some portions of each major bottom flap 430 are disposed external to the opposite major bottom flap 430 other portions of each major bottom flap 430 are disposed internal to the opposite major bottom flap 430.

In this example, the bottom major flaps 430 extend from the first wall panel 406 and the third wall panel 410, and the bottom minor flaps 428 extend from the second wall panel 408 and the fourth wall panel 412, however, in other examples, this can be reversed. Moreover, although the bottom flaps 428, 430 in this example are configured to fasten together through a combination of adhering and mechanical coupling, in other examples, the bottom flaps can be configured to fasten together in other manners, including via adhering, taping, or mechanical coupling of the flaps, among other manners known to those skilled in the art. In such alternative examples, the bottom flaps 428, 430 may have different shapes than those shown herein. For example, each of the bottom flaps 428, 430 may have simple rectangular shapes with the minor bottom flaps 428 folded underneath, the major bottom flaps 430 folded overtop at least a portion of and adhered to the minor bottom flaps 428 with an adhesive.

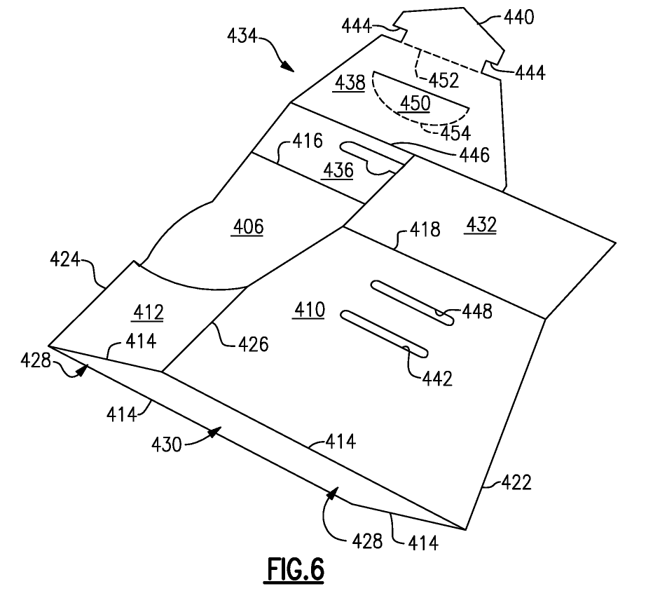

From the partially-erected state described above, the pack 100 can be flattened to the state shown in FIG. 6. Re-flattening of the partially-erected pack 100 includes collapsing the partially-erected pack by folding at the wall fold lines 420, 422, 424, 426 with two wall panels laying on top of the other two wall panels. In an example, diagonal fold lines 404 can be included in the major bottom flaps 430 to allow the partially-erected pack 100 to be re-flattened to the state shown in FIG. 6 with the bottom flaps 428, 430 fastened together. The diagonal fold lines 404 enable the bottom flaps 428, 430, with the major bottom flaps 430 adhered to the respective minor bottom flaps 428, to fold inward along the bottom fold lines 414, which demarcate the flaps 428, 430 from their respective wall panels 406, 408, 410, 412, and lay flat in between the two pairs of wall panels 420, 422, 424, 426.

Re-flattening of the partially-erected pack 100 may be desirable in examples in which the pack 100 is erected in a two stage process comprising an earlier stage and a later stage. The earlier stage can take place at a first facility or location that constructs the pack 100 up to the partially-erected state with bottom flaps fastened together stage as discussed above. The partially-erected pack can then be re-flattened and shipped to another facility where the latter stage construction occurs. This latter stage includes construction of the rest of the pack 100 including filling of the pack 100 with product. Re-flattening of the pack in such a situation reduces the space that each partially-erected pack takes up during transit between the two facilities/locations. In an example, the both the earlier and later stages of construction can be performed by hand (i.e., a person manipulating the blank 400 directly with their hands). In other examples, one or both of the earlier or later stages can be performed with a machine manipulating the blank 400.

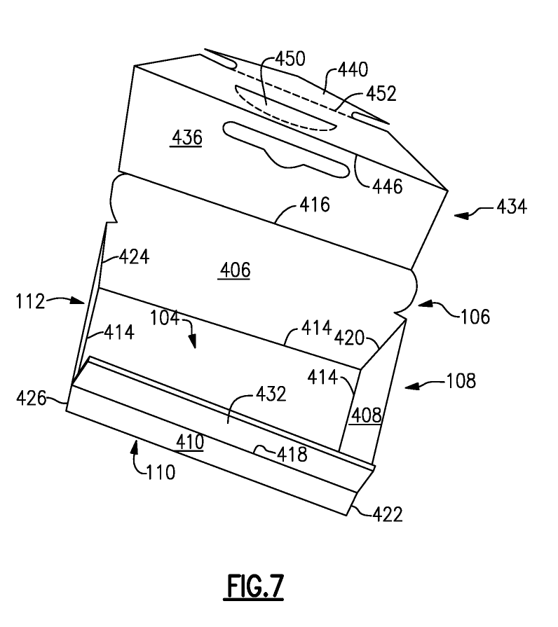

In any case, if the partially-erected pack is re-flattened, the flattened pack can be re-expanded to continue constructing the pack 100 (e.g., at the second location). Re-expanding the partially-erected pack includes folding the flattened pack shown in FIG. 6 at the wall fold lines 420, 422, 424, 426 to an expanded state in which a rectangular tube is formed with each wall panel disposed at approximately a ninety-degree angle from the adjacent wall panels. An example of such an expanded state is shown in FIG. 7.

The act of expanding the wall panels 406, 408, 410, 412 to their approximately ninety-degree relative angle may not cause the bottom flaps 428, 430 to extend to their final position, which is perpendicular to the wall panels 406, 408, 410, 412. Thus, as or after the wall panels 406, 408, 410, 412 are being expanded, the bottom flaps 428, 430 can be pushed outward from inside the wall panels 406, 408, 410, 412, such that the bottom flaps 428, 430 are oriented perpendicularly to the wall panels 406, 408, 410, 412.

Once the pack is expanded, product can be placed into the partially-erected pack. In this example, the product includes a plurality (e.g., 5-6) of flexible packets which are aligned and placed into the partially-erected pack.

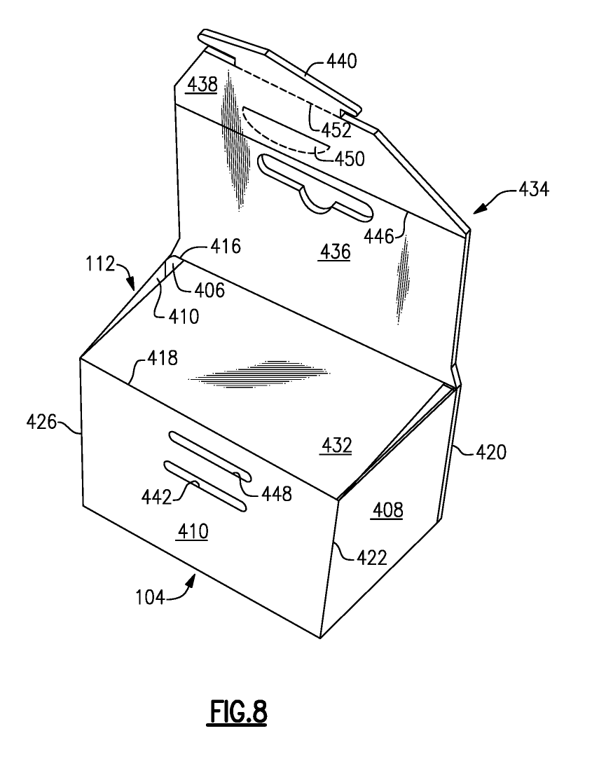

Once the product is in the partially-erected pack, the top 102 can be closed to secure the product in the pack 100. FIG. 7 is a view of the partially-erected pack with the top 102 open. Closing the top 102 includes folding the top flaps 432, 434 inward at the top fold lines 416, 418, such that the top flaps 432, 434 are perpendicular to the wall panels 406, 408, 410, 412. The first top flap 432 extending from the third wall panel 410 can be folded inward before the second top flap 434 extending from the first wall panel 406. In this example, the first top flap 432 extending from the third wall panel 410 remains floating in the fully constructed configuration of pack 100. That is, the first top flap 432 is not fastened to any of the wall panels 406, 408, 410, 412 or to the second top flap 434. Instead, the first top flap 432 is folded to an orientation that is perpendicular to the wall panels and covers at least a portion of the product in the pack 100, and is left in that position without fastening to any other part of the pack 100. FIG. 8 is a view of the pack 100 during closing of the top with the first top flap 432 folded inward and before the second top flap 434 is folded inward.

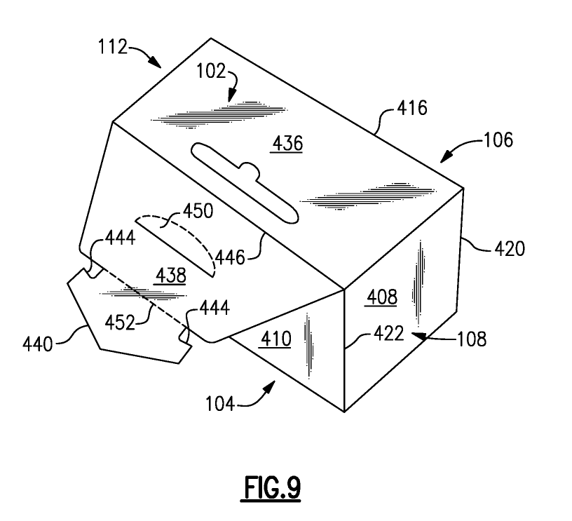

Once the first top flap 432 is folded inward, the second top flap 434 can be folded inward over the first top flap 432. In particular, the second top flap 434 can be folded to an orientation that is perpendicular to the wall panels 406, 408, 410, 412 and covers at least a portion of the products in the pack 100, which is parallel with the first top flap 432. FIG. 9 is a view of the pack with the second top flap 434 folded over in this position. In this example, the second top flap 434 includes an intermediate panel 436 and a distal panel 438. The intermediate panel 436 is disposed over at least a portion of the first top flap 432 when the second top flap 434 is folded perpendicular to the wall panels 406, 408, 410, 412 as shown in FIG. 9. In this position, the distal panel 438 extends beyond the top 102 of the pack 100 and can be folded downward to be parallel with, and lie against, the third wall panel 410.

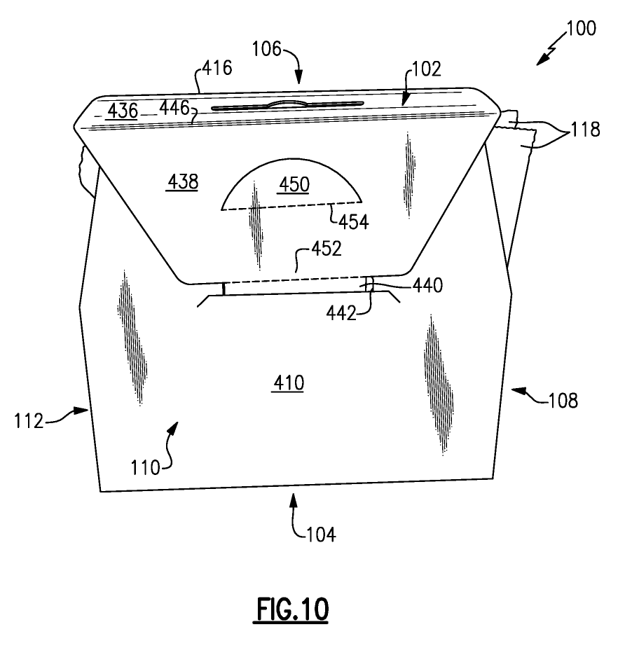

The distal panel 438 can then be fastened to the third wall panel 410 to secure the top 102 of the pack 100. In this example, the distal panel 438 can be fastened to the third wall panel 410 by including a tab 440 defined therein that is configured to be inserted into a slot 442 defined in the third wall panel 410. In this example, the tab 440 includes a plurality of shoulder edges 444 which face back towards the mid-flap fold 446 between the intermediate panel 436 and the distal panel 438. The shoulder edges 444 extend wider than the slot in the third wall panel 410 such that once the tab 440 is inserted into the slot 442, the shoulder edges 444 will contact the third wall panel 410 adjacent the slot 442 to resist pulling the tab 440 out from the slot 442. FIG. 10 is a back view of the pack 100 showing the tab 440 of the second top flap 434 inserted into the slot 440. In other examples, the distal panel 438 can be fastened to the third wall panel 410 in other manners, such as using a one-time use, or re-sealable, adhesive. In examples where an adhesive is used, the shape of distal panel 438 may be different, including the lack of a tab 440 and/or shoulder edges 444. Additionally, the slot(s) 442, 448 may not be present in the third wall panel 410 if an adhesive is used instead of a tab 440 to fasten second top flap 434 to the third wall panel 410.

In this example, a line of weakness 452 (e.g., a perforated line) is included in the distal panel 438 at a base of the tab 440. The shoulder edges 444 are distal to the line of weakness 452 such that after the tab 440 is inserted into the slot 442, the line of weakness 452 can be broken to separate the tab 440 from the rest of the distal panel 438. This separation allows the pack 100 to be opened by folding open of the second top flap 434 to access the product(s) 118 in the pack 100. The sizes of the tab 440 including the shoulder edges 444 and the slot 442 can be coordinated such that the tab 440 can be inserted into the slot 442, but cannot be easily removed without breaking of the line of weakness 452. Thus, the line of weakness 452 can act as a tamper indicator, as the pack 100 cannot be easily opened via folding open of the second top flap 434 without breaking the line of weakness 452. The line of weakness 452 can be configured to break in response an appropriate force pulling the second top flap 434 upward, causing the shoulder edges 444 to contact the third wall panel 410 adjacent the slot 442.

In this example, a second slot 448 is included in the third wall panel 410. The second slot 448 is parallel to and closer to the top 102 than the first slot 442. The second slot 448 works in conjunction with a releasable tab 450 in the distal panel 438 to provide a re-close feature for the pack 100. After the line of weakness 452 is broken and the pack 100 is opened, the pack 100 can be re-closed by breaking a second line of weakness 454 (e.g., a perforated line) to release the releasable tab 450. The first top flap 432 and second top flap 434 can then be re-folded over the top 102 of the pack 100, and the releasable tab 450 can be inserted into the second slot 448 to hold the distal end 438 of the second top flap 434 against the third wall panel 410. This holds the first top flap 432 and the second top flap 434 closed so that any product(s) 118 not used after the initial opening of pack 100 can be secured in the pack 100 for later use.

The configuration of the first top flap 432 and the second top flap 434 can enable easier closing of the top 102 while preserving the entire outside surface area of the first top flap 432 for indicia to be marked thereon. For example, if an adhesive were used to fasten the second top flap 434 to the first top flap 432 and/or the third wall panel 410, the adhesive would make it difficult to utilize some portions of the outer surface of the first top flap 432 and/or the third wall panel 410 for indicia. The configuration of the first top flap 432 as floating, however, preserves the outside surface area of the first top flap 432 for marking of indicia. Such indicia would be visible to the consumer as they are opening the pack 100, i.e., when the second top flap 434 is folded open, but before the first top flap 432 is folded open.

Additionally, having a first top flap 432 that requires only a single fold to close (fold along the top fold line 418), makes it easy to fold downward by hand. Also, the first top flap 432 can be configured to have dimensions such that when the first top flap 432 is folded inward to a position perpendicular to the wall panels 406, 408, 410, 412, the edge of the first top flap 432 abuts the top fold line 416 of the first wall panel 406. Thus, during hand folding of the second top flap 434, the edge of the first top flap 432 can be held against the top fold line 416 to provide a support about which the second top flap 434 can be folded. Bracing the top fold line 416 during folding of the second top flap 434 can help create a sharper corner and ensure the fold occurs along the top fold line 416. This aids in creating a flat top 102 and avoiding an unwanted “domed” effect on the top 102. Also, once the pack 100 is fully constructed, the contact between the edge of the first top flap 432 and the top fold line 416 can add additional rigidity to the pack 100.

Finally, utilizing a tab 440 and slot 442 to fasten the second top flap 434 to the third wall panel 410 provides an easy means to fasten the second top flap 434 by hand and also provides the ability to use a line of weakness 452 as a tamper indicator.

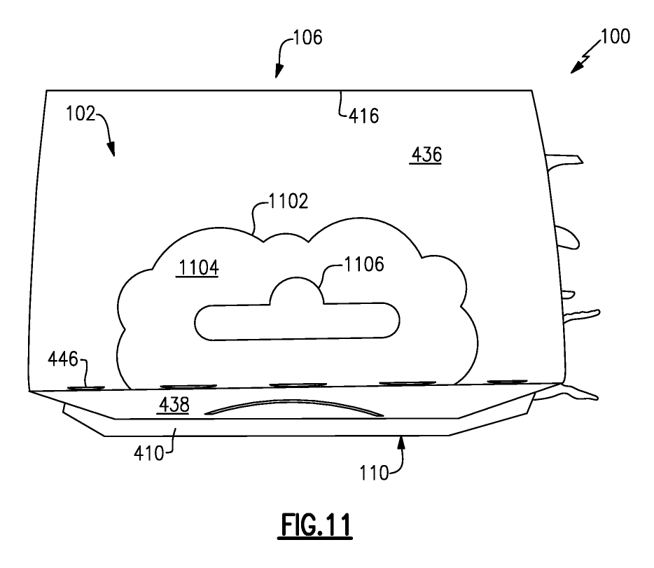

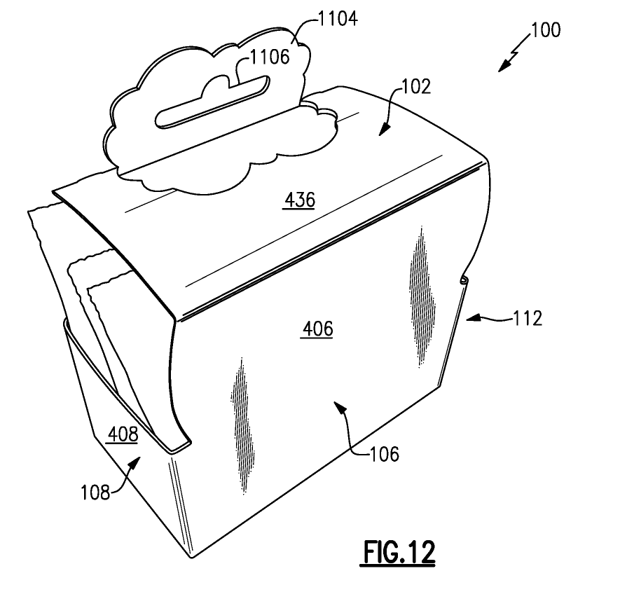

FIG. 11 is a top view of the pack 100. In an example, the intermediate panel 436 of the second top flap 434 includes a third line of weakness 1102 (e.g., a perforated line) defined therein. The third line of weakness 1102 extends from the mid-flap fold 446 (between the distal panel 438 and the intermediate panel 436) across the surface of the intermediate panel 436 and returns back to the mid-flap fold 446 to form a releasable flap 1104 from a portion of the intermediate panel 436. Breaking the line of weakness 1102 separates the releasable flap 1104 from the remaining portion of the intermediate panel 436. The releasable flap 1104 can then be folded outward about the mid flap fold 446 to be aligned with the third wall panel 410. The releasable flap 1104 can include a slot 1106 to enable the pack 100 to be hung on a post or the like. FIG. 12 is a view of the pack 100 with the releasable flap 1104 folded outward. Although a particular configuration of flap 1104 is shown in FIG. 12, releasable flap 1104 can be provided in any desired shape and may desirably be provided with a shape that corresponds to another shape or indicia used or that appears in pack 100.

Advantageously, marking can be achieved on one or more (e.g., all) of the outer surfaces of the walls 106, 108, 110, 112, and/or on the outer surfaces of the first top flap 432 and the second top flap 434 by marking on only a single side of the unfolded (planar) blank 400, as each of these surfaces originate on the same side of the blank 400. This can reduce marking costs by marking only on one side of the blank 400, not on the other side. In other examples both sides of the blank 400 can include indicia. Marking of indicia can be performed in any suitable manner including ink jet printing, rotogravure printing, laser marking, or other marking means.

1. A pack comprising:
a unitary blank folded into a rectangular cuboid, the rectangular cuboid defining:
a bottom;
a top approximately parallel to and opposite of the bottom; and
four walls approximately perpendicular to and disposed between the top and the bottom, the four walls including a first wall, a second wall, a third wall, and a fourth wall, the first wall opposite of the third wall, and the second wall opposite of the fourth wall,
wherein the second wall defines a first opening into the interior of the cuboid and the fourth wall defines a second opening into the interior of the cuboid, the first and second openings extending from the first wall to the third wall of the cuboid in a direction parallel to a bottom plane of the cuboid and from the top to an upper edge of the second and fourth walls respectively in a direction normal to the bottom plane of the cuboid and wherein the upper edge of the second and fourth walls is disposed at a height of 50 percent or greater of a distance from the bottom to the top of the cuboid.

2. The pack of claim 1, wherein the top includes a first top flap and a second top flap disposed over at least a portion of the first top flap, the first top flap integral with a third wall of the cuboid and the second top flap integral with a first wall of the cuboid,
wherein the second top flap includes an intermediate panel parallel with the first top flap and defined by a fold with the third wall and by a mid-flap fold with a distal panel of the second top flap, the distal panel of the second top flap disposed over at least a portion of and parallel to the third wall and fastened thereto.

3. The pack of claim 2, wherein the distal panel of the second top flap defines a tab, wherein the third wall of the cuboid defines a slot, wherein the distal panel is fastened to the third wall by insertion of the tab into the slot.

4. The pack of claim 3, wherein the tab defines first and second shoulder edges facing back towards the fold between the distal panel and the intermediate panel of the second top flap,
wherein the first and second shoulders edges extend wider than the slot such that the first and second shoulder edges contact the third wall of the cuboid adjacent the slot to resist pulling out of the tab from the slot.

5. The pack of claim 2, wherein the first top flap is floating.

6. The pack of claim 5, wherein the first top flap is defined proximate the third wall by a fold with the third wall, proximate the second wall by a first edge, proximate the first wall by a second edge, proximate the fourth wall by a third edge, wherein the second edge abuts the fold between the first wall and the second top flap.

7. The pack of claim 6, wherein the first and third edges of the first top flap and corresponding edges of the intermediate panel extend to within 2 cm of respective planes defined by the second wall and the fourth wall of the cuboid.

8. The pack of claim 2, wherein the unitary blank is composed of paperboard.

9. The pack of claim 2, wherein an outer surface of each of the four walls, and an outward facing surface of the first top flap originate from a single side of the unitary blank.

10. The pack of claim 2, comprising:
a line of weakness defined between the tab and a remaining portion of the distal panel, the line of weakness configured to break to separate the tab from the remaining portion of the distal panel thereby unfastening the second top flap from the third wall.

11. The pack of claim 10, wherein the remaining portion of the distal panel defines a second line of weakness which defines a releasable flap,
wherein the third wall defines a second slot parallel to the first top flap,
wherein the releasable flap is configured to be released from the distal panel by breaking of the second line of weakness and to be inserted into the second slot to reclose the pack by securing the second top flap to the third wall.

12. The pack of claim 2, wherein the intermediate panel includes a third line of weakness, the third line of weakness extending from the mid-flap fold, the third line of weakness extending across the intermediate panel and returning to the mid-flap fold to form a second releasable flap from a portion of the intermediate panel,
wherein after breaking the third line of weakness, the second releasable flap is foldable away from a remaining portion of the intermediate panel, by folding along the mid-flap fold,
wherein the second releasable flap defines an aperture therein for hanging of the pack on a hook.

13. The pack of claim 1, comprising a plurality of packages disposed therein, each package having a planar geometry oriented in parallel with the first and third walls, each package extending substantially from the bottom to the top and from the second wall to the fourth wall.

14. A pack comprising:
a unitary blank folded into a rectangular cuboid, the rectangular cuboid defining:
a bottom;
a top parallel to and opposite of the bottom; and
four walls perpendicular to and disposed between the top and the bottom, the four walls each formed of a respective wall panel, the wall panels including a first wall panel, a second wall panel, a third wall panel, and a fourth wall panel, the first wall panel opposite of the third wall panel, and the second wall panel opposite of the fourth wall panel,
wherein respective wall folds form a boundary between the first wall panel and the second wall panel, between the second wall panel and the third wall panel, and between the first wall panel and the fourth wall panel, wherein a fourth wall fold forms a boundary between the third wall panel and a tube-forming flap, the tube-forming flap fastened to the fourth wall panel,
wherein the bottom is formed of a plurality of bottom flaps extending from respective wall panels, at least two of the bottom flaps fastened together,
wherein the top is formed of a first top flap extending from the third wall panel and a second top flap extending from the first wall panel, wherein the first top flap is floating, and the second top flap is disposed over at least a portion of the first top flap, the second top flap including an intermediate panel and a distal panel having a mid-flap fold therebetween, the intermediate panel disposed over at least a portion of the first top flap and the distal panel disposed over a portion of, and fastened to, the third wall panel.

15. The pack of claim 14, wherein the first top flap is defined proximate the third wall by a fold with the third wall, proximate the second wall panel by a first edge, proximate the first wall panel by a second edge, proximate the fourth wall panel by a third edge, wherein the second edge abuts the fold between the first wall panel and the second top flap.

16. A method of erecting a pack, the method comprising:
forming a rectangular tube having four perpendicular walls and a bottom;
placing items in the rectangular tube;
folding a first top flap inward, such that the first top flap is perpendicular to a third wall of the tube from which the first top flap extends;
folding a second top flap inward, such that the second top flap is parallel to and disposed over at least a portion of the first top flap;
folding a distal end of the second top flap, which extends beyond the first top flap, such that the distal end of the second top flap is parallel to the third wall of the tube; and
fastening the distal end of the second top flap to the third wall of the tube.

17. The method of claim 16, wherein fastening includes inserting a tab defined in the distal end of the second top flap into a slot in the third wall of the tube.

18. The method of claim 17, wherein the tab defines first and second shoulder edges facing back towards the fold between the distal end an intermediate panel of the second top flap,
wherein the first and second shoulders edges extend wider than the slot such that the first and second shoulder edges contact the first wall of the tube to resist pulling out of the tab from the slot.

19. The method of claim 16, wherein forming a rectangular tube includes expanding a flattened sleeve to a form the rectangular tube,
wherein the flattened sleeve includes a plurality of bottom flaps folded inward and disposed parallel to a wall panel from which the bottom flaps extend,
at least two of the plurality of bottom flaps defining respective features which are mechanically coupled with one another upon expanding of the flattened sleeve into a tube.

20. (canceled)
